(19) United States
(12) Patent Application Publication
(10) Pub. No.: US 2026/0062891 A1
(43) Pub. Date: Mar. 5, 2026

(54) REMOTE OPERATION SYSTEM

(71) Applicant: SUMITOMO HEAVY INDUSTRIES, LTD., Tokyo (JP)

(72) Inventors: Solmon JEONG, Kanagawa (JP); Takatoshi ITO, Kanagawa (JP)

(21) Appl. No.: 19/308,713

(22) Filed: Aug. 25, 2025

(30) Foreign Application Priority Data
Aug. 30, 2024 (JP) 2024-149990

(51) Int. Cl. E02F 9/20; E02F 9/12; E02F 9/22; E02F 9/26; G05D 1/224; G05D 107/90; G06F 3/16

(52) U.S. Cl. CPC E02F 9/205; E02F 9/261; G05D 1/2247; G06F 3/16; E02F 9/123; E02F 9/2203; E02F 9/2253; E02F 9/2285; E02F 9/2292; E02F 9/2296; G05D 2107/90

(57) ABSTRACT

A remote operation system includes: a work machine including an imaging device that captures a video around the work machine, a detection device that detects additional information other than the video, and a first communication device that transmits the video and the additional information; a remote operation room including an operation device, a second communication device that transmits operation information from the operation device to the first communication device and receive the video and the additional information, a display device that displays the video, and an output device that outputs the additional information; and a control device that performs control to transmit or receive essential information and the additional information between the first communication device and the second communication device. The control device controls each of the essential information and the additional information differently based on a communication status between the first communication device and the second communication device.

### CROSS-REFERENCE TO RELATED APPLICATIONS

This application is based on and claims priority to Japanese Patent Application No. 2024-149990, filed on Aug. 30, 2024, the entire contents of which are incorporated herein by reference.

### BACKGROUND

### Technical Field

The present disclosure relates to a remote operation system.

### Description of Related Art

A technique for remotely operating a work machine has been proposed. In the remote operation, an operator performs an operation while referencing a video displayed on a display device.

### SUMMARY

A remote operation system according to an embodiment of the present disclosure includes: a work machine including an imaging device configured to capture a video around the work machine, a detection device configured to detect additional information indicating information other than the video among pieces of information indicating at least one of a situation of the work machine or a situation around the work machine, and a first communication device configured to transmit the video and the additional information; a remote operation room including an operation device, a second communication device configured to transmit operation information from the operation device to the first communication device and receive the video and the additional information, a display device configured to display the video, and an output device configured to output the additional information; and a control device configured to perform control to transmit or receive essential information and the additional information between the first communication device and the second communication device, the essential information including at least one of the video or the operation information and being necessary to operate the work machine. The control device controls each of the essential information and the additional information differently based on a communication status between the first communication device and the second communication device.

### BRIEF DESCRIPTION OF THE DRAWINGS

FIG. 1 is a schematic diagram illustrating an example of a remote operation system according to a first embodiment;

FIG. 2 is a diagram illustrating an example configuration of a drive control system of a work machine according to the first embodiment;

FIG. 3 is a functional block diagram illustrating an example configuration of the remote operation system according to the first embodiment;

FIG. 4 is a diagram illustrating an example arrangement of a remote operation room according to the first embodiment;

FIG. 5 is a conceptual diagram illustrating information transmitted and received between the work machine and the remote operation room according to the first embodiment;

FIG. 6 is a diagram illustrating an example of output control of the sound volume by an output control part according to the first embodiment;

FIG. 7 is a diagram illustrating an example of a screen displayed by a display control part according to the first embodiment;

FIG. 8 is a flowchart illustrating a process in accordance with the communication status of vibration information and inclination information by a remote controller according to the first embodiment;

FIG. 9 is a flowchart illustrating a process in accordance with the communication status of a sound signal by the remote controller according to the first embodiment; and

FIG. 10 is a flowchart illustrating a process in accordance with the communication status of essential information by the remote controller according to a second embodiment.

### DETAILED DESCRIPTION

There is a possibility that an abnormality occurs in the communication between a work machine and a remote operation device. The related art proposes that a stop command be transmitted if an abnormality occurs in the communication between a work machine and a remote operation device.

A plurality of types of information are transmitted and received between the work machine and the remote operation device. The plurality of types of information include information that is essential to operate the work machine and information that is helpful to operate the work machine. That is, the plurality of types of information include information that makes remote operation difficult if transmitting or receiving the information becomes impossible, and information that is not required for remote operation to continue even if transmitting or receiving the information becomes impossible. Therefore, it is desirable to perform control according to information being transmitted or received in a case where an abnormality in communication occurs.

In view of the above, each piece of information being received or transmitted is controlled based on the communication status between a work machine and a remote operation device, thereby improving safety.

According to an embodiment of the present disclosure, safety is improved by controlling each piece of information being received or transmitted, differently based on the communication status.

Embodiments of the present disclosure will be described below with reference to the accompanying drawings. The embodiments described below are merely examples and are not intended to limit the present invention. All features and combinations thereof in the embodiments of the present disclosure are not necessarily essential to the present invention. In the drawings, the same or corresponding components are denoted by the same or corresponding reference numerals, and duplicate descriptions may be omitted.

A work machine 100 according to an embodiment of the present disclosure is a shovel. The work machine 100 may be a machine other than the shovel, such as a crane, an asphalt finisher, or a forklift. In the illustrated example, the shovel as the work machine 100 is an excavator including a bucket 6 as an end attachment, but may be an application machine such as a forestry machine including an end attachment other than the bucket 6. Further, the work machine 100 may be a crawler crane including a lower traveling body, an upper turning body, and an attachment provided on the upper turning body.

### First Embodiment

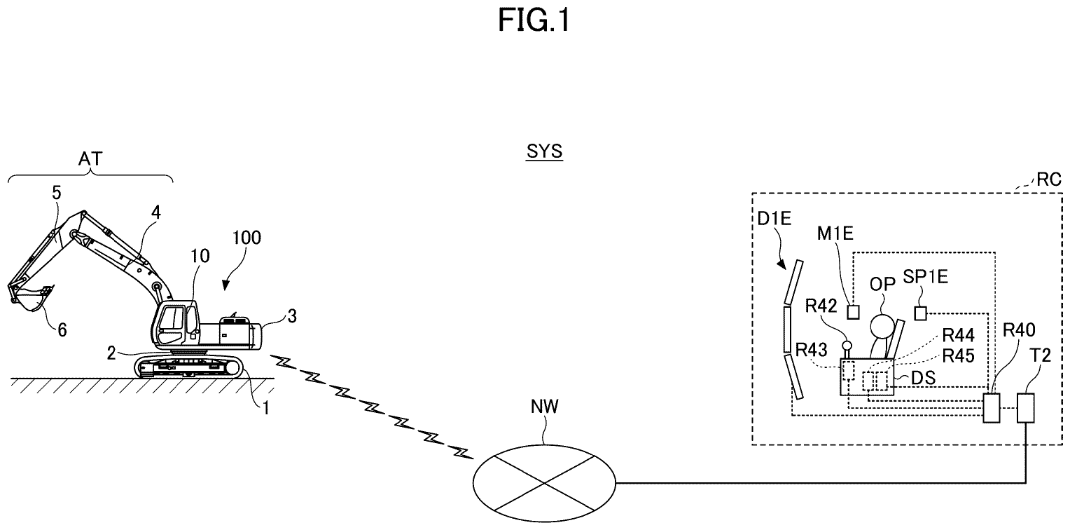

First, an outline of a remote operation system SYS according to a first embodiment will be described with reference to FIG. 1. FIG. 1 is a schematic diagram illustrating an example of the remote operation system SYS according to the first embodiment.

### Devices/Equipment Included in Remote Operation System

As illustrated in FIG. 1, the remote operation system SYS according to the first embodiment includes the work machine 100 and a remote operation room RC.

The work machine 100 and the remote operation room RC are connected to each other so as to enable data transmission and reception via a communication line NW.

The work machine 100 can perform wireless communication. The work machine 100 can transmit and receive data to and from a device or equipment (for example, the remote operation room RC) connected to the communication line NW.

The work machine 100 is present at a work site where the work machine 100 performs work. The work machine 100 can transmit information on the work site to the remote operation room RC. This allows the remote operation room RC to check the work site in response to the information from the work machine 100. In the present embodiment, a device that performs measurements at the work site is not limited to the work machine 100, and may be any other type of device, such as a fixed-point measurement device present at the work site, a drone that flies over the work site, or an imaging device that can be carried by a user.

The number of work machines 100 included in the remote operation system SYS may be one or more.

Accordingly, the remote operation system SYS can provide information about the work site to the remote operation room RC through the one or more work machines 100.

### Example Configuration of Remote Operation Room

The remote operation room RC includes a communication device T2, a remote controller R40, an operation device R42, an operation sensor R43, a display device D1E, a sound collecting device M1E, a sound output device SP1E, a vibration device R44, and an oscillation device R45. In addition, an operation seat DS on which a remote operator OP who remotely operates the work machine 100 is seated is installed in the remote operation room RC.

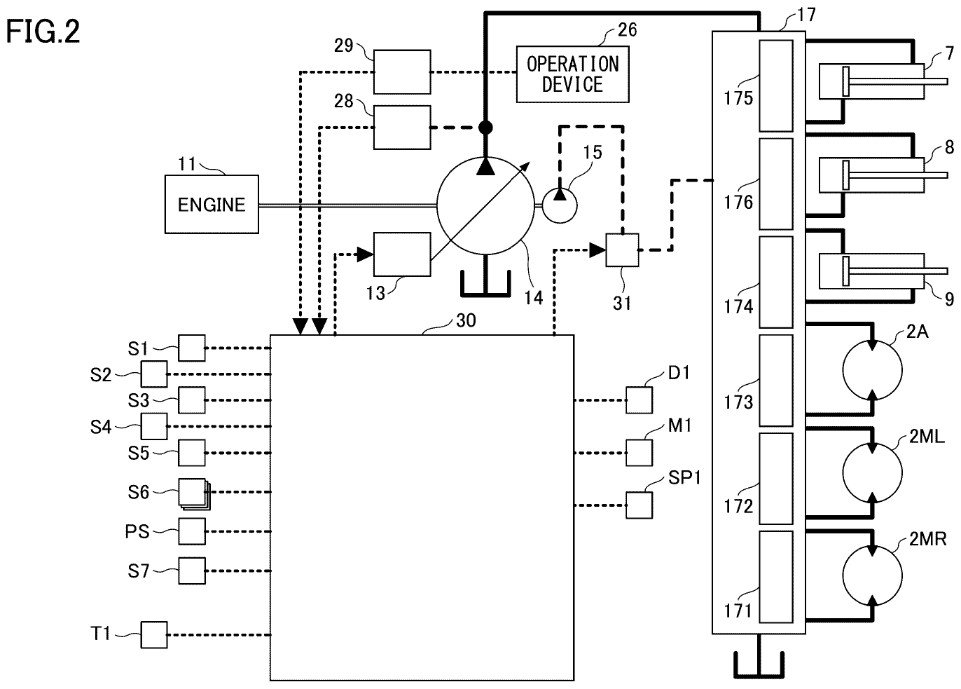

The communication device T2 (an example of a second communication device) is configured to control communication with a communication device T1 (see FIG. 2) attached to the work machine 100.

The remote controller R40 (an example of a control device) is an information processing device that performs various calculations. In the present embodiment, the remote controller R40 is configured with a microcomputer including a central processing unit (CPU) and a memory. Various functions of the remote controller R40 are implemented by the CPU executing programs stored in the memory.

The display device D1E displays a screen based on information transmitted from the work machine 100 such that the remote operator OP in the remote operation room RC can visually recognize the surroundings of the work machine 100. The display device D1E allows the operator to confirm the situation of the work site including the surroundings of the work machine 100 even when the operator is in the remote operation room RC.

The operation device R42 (an example of an operation part) is provided with the operation sensor R43 for detecting the content of an operation of the operation device R42. The operation sensor R43 is, for example, an inclination sensor that detects the inclination angle of an operation lever, an angle sensor that detects the oscillation angle around the oscillation axis of the operation lever, or the like. The operation sensor R43 may be configured with any other sensor such as a pressure sensor, a current sensor, a voltage sensor, or a distance sensor. The operation sensor R43 outputs information about the detected content of the operation of the operation device R42 to the remote controller R40. The remote controller R40 generates an operation signal based on the received information and transmits the generated operation signal to the work machine 100. The operation sensor R43 may be configured to generate an operation signal. In this case, the operation sensor R43 may output the operation signal to the communication device T2 without using the remote controller R40. Accordingly, the remote operation of the work machine 100 can be achieved from the remote operation room RC.

The sound collecting device M1E is a device that collects sound generated in the remote operation room RC. In the illustrated example, the sound collecting device M1E is an indoor microphone, and is configured to pick up voices uttered by the remote operator OP in the remote operation room RC.

The sound output device SP1E can output various kinds of sound information. The sound output device SP1E outputs sound based on information transmitted from the work machine 100 so that the remote operator OP in the remote operation room RC can hear the sound emitted at the work site. For example, the sound output device SP1E is configured to output sound captured by a sound collecting device M1 (see FIG. 2) installed outside the work machine 100. The sound output device SP1E may be an installed device such as a speaker or a wearable device such as an earphone or a headphone. The speaker may be a monaural speaker, a stereo speaker, or a surround speaker. Further, the speaker may be a non-directional speaker or a directional speaker. The wearable device may have a noise canceling function, a spatial audio function (stereo sound function), or a bone conduction function. The vibration device R44 vibrates the operation seat DS on which the remote operator OP is seated with amplitudes and frequencies according to control from the remote controller R40. The vibration device R44 is configured to output vibration detected by a vibration detection device S7 (see FIG. 2) attached to the work machine 100, for example. Note that an object to be vibrated by the vibration device R44 according to the present embodiment is not limited to the operation seat DS, and may be, for example, the operation device R42 or the like.

The oscillation device R45 oscillates (inclines) the operation seat DS on which the remote operator OP is seated according to control from the remote controller R40. The oscillation device R45 is configured to reproduce, for example, the inclination of the work machine 100, detected by a machine body inclination sensor S4 (see FIG. 2) attached to the work machine 100, with respect to the operation seat DS. In the present embodiment, an example in which the oscillation device R45 oscillates (inclines) the operation seat DS with respect to the inclination of the work machine 100 will be described. However, in the present embodiment, a method of causing the remote operator OP to recognize the inclination of the work machine 100 is not limited to a method of causing the oscillation device R45 to oscillate (incline) the operation seat DS. For example, the remote controller R40 may display the current inclination angle of the work machine 100 on the display device D1E in a recognizable manner.

The work machine 100 includes a lower traveling body 1, an upper turning body 3 turnably mounted on the lower traveling body 1 via a turning mechanism 2, an attachment AT for performing various kinds of work, and a driving room 10. The driving room 10 is also referred to as a cabin or a cab. The front side of the work machine 100 (upper turning body 3) corresponds to the side on which the attachment AT is attached to the upper turning body 3 when the work machine 100 is viewed from the top along the turning axis of the upper turning body 3. The left side, the right side, and the rear side of the work machine 100 (upper turning body 3) correspond to the left side, the right side, and the rear side respectively, as viewed from the operator seated on a driving seat in the driving room 10.

The lower traveling body 1 includes, for example, a pair of left and right crawlers (not illustrated). Specifically, the crawlers include a left crawler and a right crawler. The left crawler is driven by a left travel hydraulic motor 2ML (see FIG. 2), and the right crawler is driven by a right travel hydraulic motor 2MR (see FIG. 2). The left travel hydraulic motor 2ML is a travel driving part that drives the left crawler serving as a driven part and can rotate the left crawler. The right travel hydraulic motor 2MR is a travel driving part that drives the right crawler serving as a driven part and can rotate the right crawler. Each of the travel driving parts may be an electric motor.

A boom 4 is rotatably attached to the front center of the upper turning body 3, an arm 5 is rotatably attached to the tip of the boom 4, and the bucket 6 is rotatably attached to the tip of the arm 5. In the illustrated example, the boom 4, the arm 5, and the bucket 6 constitute an excavation attachment that is an example of the attachment AT. The boom 4, the arm 5, and the bucket 6 are driven by a boom cylinder 7, an arm cylinder 8, and a bucket cylinder 9, respectively.

The bucket 6 is an example of a work tool (end attachment). The bucket 6 is used for, for example, excavation work or the like. Other work tools may be attached to the tip of the arm 5 in place of the bucket 6 depending on the work content or the like.

The other work tools may be other types of buckets such as large buckets, slope buckets, and dredging buckets. Alternatively, the other work tools may be types of work tools other than buckets, such as agitators, breakers, grapples, and lifting magnets. The excavation attachment may be provided with a bucket tilt mechanism.

In the work machine 100, all or some of driven parts such as the lower traveling body 1, the upper turning body 3, the boom 4, the arm 5, and the bucket 6 may be electrically driven. That is, the work machine 100 may be a hybrid shovel or an electric shovel in which all or some of the driven parts are driven by an electric actuator.

The work machine 100 according to the present embodiment is configured to be remotely operated from the outside of the work machine 100. When the work machine 100 is remotely operated, the inside of the driving room 10 may be in an unmanned state.

Further, the work machine 100 may automatically move actuators regardless of an operation of the operator. Thus, the work machine 100 implements a function for automatically moving at least some of the driven parts such as the lower traveling body 1, the upper turning body 3, the boom 4, the arm 5, and the bucket 6, that is, what is referred to as a “machine control function”.

FIG. 2 schematically illustrates an example configuration of the work machine 100. In FIG. 2, a mechanical power transmission system, a hydraulic oil line, a pilot line, and an electric control system are indicated by a double line, a bold solid line, a bold dashed line, and a dotted line, respectively.

A drive system of the work machine 100 includes an engine 11, a regulator 13, a main pump 14, and a control valve unit 17. Further, a hydraulic drive system of the work machine 100 includes hydraulic actuators such as a turning hydraulic motor 2A, the left travel hydraulic motor 2ML, the right travel hydraulic motor 2MR, the boom cylinder 7, the arm cylinder 8, and the bucket cylinder 9.

The engine 11 is an example of a power source of the work machine 100, and is mounted, for example, at the rear of the upper turning body 3. The power source of the work machine 100 may be a combination of a power source such as a battery or a fuel cell and an electric motor. Specifically, the engine 11 constantly rotates at a predetermined target rotation speed as directly or indirectly controlled by a controller 30 to drive the main pump 14 and a pilot pump 15. The engine 11 is, for example, a diesel engine using diesel fuel. The engine 11 may be a gasoline engine or a hydrogen engine.

The regulator 13 controls the discharge amount of the main pump 14. For example, the regulator 13 controls the discharge amount of the main pump 14 by adjusting the angle (tilt angle) of a swash plate of the main pump 14 in response to a control instruction from the controller 30.

Similar to the engine 11, the main pump 14 is mounted, for example, at the rear of the upper turning body 3. The main pump 14 supplies hydraulic oil to the control valve unit 17 through a hydraulic oil line. In the illustrated example, the main pump 14 is a variable displacement hydraulic pump.

The control valve unit 17 is one of hydraulic control devices that control a hydraulic system in the work machine 100. In the illustrated example, the control valve unit 17 includes control valves 171 to 176. The control valve unit 17 is configured to selectively supply hydraulic oil discharged from the main pump 14 to one or more hydraulic actuators through the control valves 171 to 176. The control valves 171 to 176 control the flow rate of hydraulic oil flowing from the main pump 14 to the hydraulic actuators and the flow rate of hydraulic oil flowing from the hydraulic actuators to a hydraulic oil tank. The hydraulic actuators include the boom cylinder 7, the arm cylinder 8, the bucket cylinder 9, the left travel hydraulic motor 2ML, the right travel hydraulic motor 2MR, and the turning hydraulic motor 2A. Specifically, the control valve 171 corresponds to the left travel hydraulic motor 2ML, the control valve 172 corresponds to the right travel hydraulic motor 2MR, and the control valve 173 corresponds to the turning hydraulic motor 2A. The control valve 174 corresponds to the bucket cylinder 9, the control valve 175 corresponds to the boom cylinder 7, and the control valve 176 corresponds to the arm cylinder 8.

The pilot pump 15 is an example of a pilot pressure generating device, and is configured to supply hydraulic oil to a hydraulic control device via a pilot line. In the illustrated example, the pilot pump 15 is a fixed-capacity hydraulic pump. However, the pilot pressure generating device may be implemented by the main pump 14. That is, the main pump 14 may have a function for supplying hydraulic oil to the control valve unit 17 via a hydraulic oil line and a function for supplying hydraulic oil to various hydraulic control devices via a pilot line. In this case, the pilot pump 15 may be omitted.

A discharge pressure sensor 28 is configured to detect the discharge pressure of the main pump 14.

In the example illustrated, the discharge pressure sensor 28 outputs the detected value to the controller 30.

An operation device 26 is a device used by the operator to operate an actuator. The operation device 26 includes, for example, an operation lever an operation pedal. The actuator may be a hydraulic actuator or an electric actuator.

An operation sensor 29 is configured to detect the content of an operation performed by the operator using the operation device 26. In the present embodiment, the operating sensor 29 detects the operation direction and the operation amount of the operation device 26 corresponding to each of the actuators, and outputs the detected values to the controller 30. In the illustrated example, the controller 30 can control the opening area of a proportional valve 31 according to the output of the operating sensor 29. Then, the controller 30 supplies hydraulic oil discharged from the pilot pump 15 to a pilot port of a corresponding control valve in the control valve unit 17. The pressure (pilot pressure) of hydraulic oil supplied to each of pilot ports is, in principle, the pressure corresponding to the operating direction and the operating amount of the operation device 26 corresponding to each of the hydraulic actuators. Thus, the operation device 26 is configured to supply the hydraulic oil discharged from the pilot pump 15 to the pilot port of the corresponding control valve in the control valve unit 17.

The proportional valve 31, which functions as a control valve for machine control, is disposed in a conduit connecting the pilot pump 15 to a pilot port of a control valve in the control valve unit 17, and is configured to change the flow area of the conduit. In the illustrated example, the proportional valve 31 operates in response to a control command that is output from the controller 30. Therefore, the controller 30 can adjust the pilot pressure acting on the pilot port of the control valve by the proportional valve 31 regardless of an operation performed by the operator on the operation device 26.

With this configuration, even if a specific operation device 26 is not operated, the controller 30 can move a hydraulic actuator corresponding to the specific operation device 26.

Further, as illustrated in FIG. 2, a control system of the work machine 100 includes the controller 30, angle sensors S1, S2, and S3, the machine body inclination sensor S4, a turning sensor S5, an imaging device S6, a positioning device PS, the vibration detection device S7, the sound collecting device M1, a sound output device SP1, a display device D1, the communication device T1, and the like.

The communication device T1 communicates with external equipment through a communication network including a mobile communication network, a satellite communication network, or an Internet network. The communication device T1 may be, for example, a mobile communication module compliant with a mobile communication standard such as Long Term Evolution (LTE), 4th Generation (4G), or 5th Generation (5G), a communication module compliant with a short range wireless communication standard such as Wi-Fi (registered trade mark) or Bluetooth (registered trade mark), or a satellite communication module for connecting to a satellite communication network.

A boom angle sensor S1 detects a boom angle that is the rotation angle of the boom 4 with respect to the upper turning body 3. An arm angle sensor S2 detects an arm angle that is the rotation angle of the arm 5 with respect to the boom 4. A bucket angle sensor S3 detects a bucket angle that is the rotation angle of the bucket 6 with respect to the arm 5.

Each of the boom angle sensor S1, the arm angle sensor S2, and the bucket angle sensor S3 may be, for example, a rotary encoder, an acceleration sensor, a 6-axis sensor, an inertial measurement unit (IMU), or the like, or may be a potentiometer using a variable resistor, a cylinder stroke sensor that detects the stroke amount of a hydraulic cylinder, or the like.

A detection signal corresponding to the boom angle acquired by the boom angle sensor S1, a detection signal corresponding to the arm angle acquired by the arm angle sensor S2, and a detection signal corresponding to the bucket angle acquired by the bucket angle sensor S3 are taken into the controller 30. A detection signal may include an angular velocity in addition to an angle.

In the present embodiment, the boom angle sensor S1, the arm angle sensor S2, and the bucket angle sensor S3 are also referred to as the angle sensors S1, S2, and S3, respectively.

The machine body inclination sensor S4 (an example of a detection device) detects the inclination state of a body (the lower traveling body 1 or the upper turning body 3) with respect to a horizontal plane. The machine body inclination sensor S4 is attached to, for example, the upper turning body 3, and detects the inclination angles of the work machine 100 (that is, the upper turning body 3) around two axes in the front-rear direction and the left-right direction. The machine body inclination sensor S4 may be, for example, an acceleration sensor, a 6-axis sensor, an IMU, or the like. Detection signals corresponding to the inclination angles detected by the machine body inclination sensor S4 are taken into the controller 30.

The turning sensor S5 outputs information about the turning of the upper turning body 3. The turning sensor S5 detects, for example, the turning angle speed of the upper turning body 3 relative to the lower traveling body 1. The turning sensor S5 may detect the turning angle. The turning sensor S5 may be, for example, a gyro sensor, a resolver, a rotary encoder, or the like. A detection signal corresponding to the turning angle or turning angle speed of the upper turning body 3 detected by the turning sensor S5 is taken into the controller 30.

The imaging device S6 is provided on the upper turning body 3, captures an image of the surroundings of the work machine 100, and acquires a video representing the surroundings of the work machine 100. The imaging device S6 includes, for example, a front camera, a left camera, a right camera, and a rear camera.

The front camera is a camera that captures an image of an area in front of the work machine 100, and is mounted on the outside of the driving room 10, such as the roof of the driving room 10 or the side surface of the boom 4. The left camera is a camera that captures an image of an area to the left of the work machine 100, the right camera is a camera that captures an image of an area to the right of the work machine 100, and the rear camera is a camera that captures an image of an area to the rear of the work machine 100. Specifically, each of the front camera, the left camera, the right camera, and the rear camera is a monocular wide-angle camera equipped with an imaging device such as a CCD or a CMOS. Information on the captured images is taken into the controller 30. Further, the images captured by the imaging device may be output to the display device D1.

The imaging device S6 may constitute an object detection device that detects objects around the work machine 100. The object detection device may be configured with a device other than a camera. For example, the object detection device may be a LiDAR. The LiDAR is a device that can measure the distance between a point group of one million or more points within a monitoring range and the LiDAR (laser source). The object detection device may be another device that can measure the distance to an object, such as a stereo camera, a range image camera, or a millimeter-wave radar. When a millimeter-wave radar or the like is used as the object detection device, the object detection device may derive the distance to and the direction of an object by transmitting a large number of signals (laser light or the like) toward the object and receiving the reflected signals. Alternatively, the object detection device may be a combination of two or more types of devices. For example, the object detection device may be a combination of an imaging device and a LiDAR, a combination of an imaging device and a millimeter-wave radar, or a combination of an imaging device and a stereo camera.

The positioning device PS measures the position of the upper turning body 3. The positioning device PS may be, for example, a global navigation satellite system (GNSS) compass, and detects the position and the orientation of the upper turning body 3. A detection signal corresponding to the position and the orientation of the upper turning body 3 is taken into the controller 30. A function for detecting the orientation of the upper turning body 3 may be implemented by a direction sensor attached to the upper turning body 3. The positioning device PS according to the present embodiment uses a reference coordinate system, which can identify a position in the world, to measure the current position of the work machine 100.

The reference coordinate system is, for example, a world geodetic system that can identify a position on the earth. The world geodetic system is a three-dimensional orthogonal XYZ coordinate system in which the origin is located at the center of gravity of the earth, the X-axis is in the direction of the intersection of the Greenwich meridian and the equator, the Y-axis is in the direction of the 90 degrees east longitude, and the Z-axis is in the direction of the North Pole.

The vibration detection device S7 (an example of the detection device) is a device that detects vibration generated in the work machine 100. The vibration detection device S7 may be an inertial measurement unit (IMU) or the like, and detects vibration generated due to an external factor with respect to the work machine 100.

The sound collecting device M1 (an example of the detection device) is a device that collects external sound and is also referred to as a microphone or a mic. For example the sound collecting device M1 is provided in the upper turning body 3 or the driving room 10, and converts sound (air vibration) generated around the work machine 100 into mechanical vibration, and converts the mechanical vibration into electrical signals. Specifically, the external sound collecting device M1 includes a front microphone, a left microphone, a right microphone, and a rear microphone. The front microphone is a microphone that collects sound generated in front of the work machine 100, the left microphone collects sound generated on the left side of the work machine 100, the right microphone collects sound generated on the right side of the work machine 100, and the rear microphone collects sound generated at the rear of the work machine 100. Electric signals generated by the front microphone, the left microphone, the right microphone, and the rear microphone are taken into the controller 30.

The sound output device SP1 is a device that outputs sound toward the surroundings of the work machine 100. The sound output device SP1 is a non-directional speaker and is configured to output sound uniformly in all directions. However, the sound output device SP1 may be a directional speaker that outputs sound toward a particular direction such as the front.

The controller 30 is an example of the control device and is configured with a computer including, for example, a CPU, a volatile storage device, a nonvolatile storage device, and various input/output interfaces. The controller 30 implements various functions by, for example, reading a program from the nonvolatile storage device, loading the program into the volatile storage device, and causing the CPU to execute the program. In the illustrated example, the controller 30 is configured to implement various functions and control the work machine 100. The various functions include, for example, a machine guidance function for guiding a manual operation of the work machine 100 by the operator. The various functions may include a contact avoidance function for automatically or autonomously moving or stopping the work machine 100 in order to avoid contact between the work machine 100 and an object present within a monitoring range around the work machine 100.

The controller 30 is configured to output a control command to the regulator 13 as needed to change the discharge amount of the main pump 14.

Further, the controller 30 may be configured to control, for example, the machine guidance function for guiding the manual operation of the work machine 100 by the operator through the operation device 26.

Further, the controller 30 may be configured to control, for example, the machine control function for automatically supporting the manual operation of the work machine 100 by the operator through the operation device 26.

Note that some of the functions of the controller 30 may be implemented by other controllers (control devices). That is, the functions of the controller 30 may be implemented such that the functions are distributed among a plurality of controllers. For example, the machine guidance function and the machine control function may be implemented by an exclusive-use controller (control device).

### Block Configuration of Remote Operation System

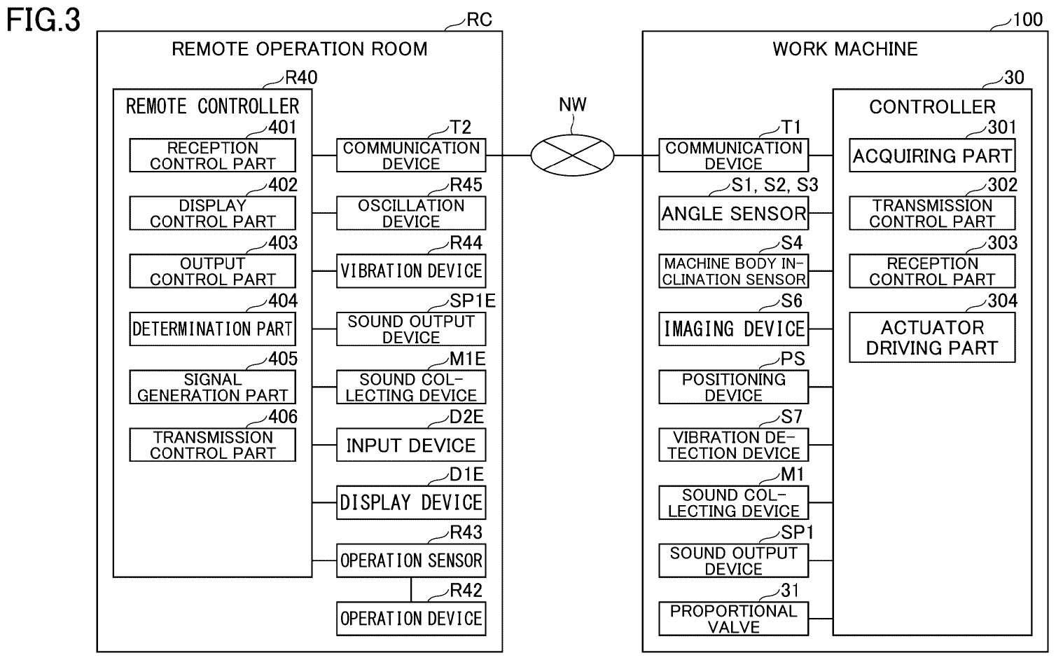

FIG. 3 is a functional block diagram illustrating an example configuration of the remote operation system SYS according to the present embodiment. In the example illustrated in FIG. 3, a block configuration of each of the remote operation room RC and the work machine 100 included in the remote operation system SYS is illustrated. Note that a description of a hardware configuration of the work machine 100 will be omitted.

### Configuration of Remote Operation Room RC

The remote operation room RC includes the remote controller R40, the communication device T2, the operation sensor R43, the operation device R42, the vibration device R44, the oscillation device R45, the sound collecting device M1E, the sound output device SP1E, the display device D1E, and an input device D2E. The communication device T2, the operation sensor R43, the operation device R42, the vibration device R44, the oscillation device R45, the sound collecting device M1E, and the sound output device SP1E have been described above, and thus the description thereof will be omitted.

The input device D2E is provided within reach of the operator seated in the remote operation room RC, receives various kinds of operation inputs by the operator, and outputs signals corresponding to the operation inputs to the remote controller R40. The input device D2E includes a touch panel mounted on a display of a display device that displays various information images, a knob switch provided at the tip of a lever of the operation device R42, a button switch, a lever, a toggle switch, and a rotary dial provided around the display device D1E, and the like.

A signal corresponding to the content of an operation with respect to the input device D2E is taken into the remote controller R40.

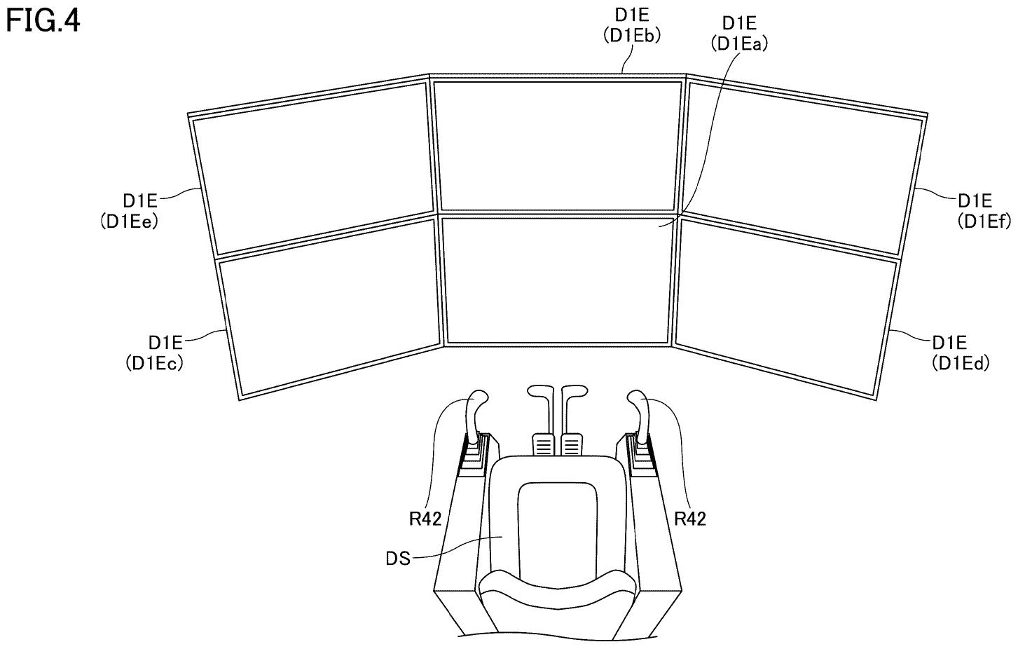

Next, the remote operation room RC will be described. FIG. 4 is a diagram illustrating an example of the arrangement of the remote operation room RC. In the remote operation room RC, a plurality of operation devices R42 are provided around the operation seat DS. In the present embodiment, as illustrated in FIG. 4, the display device D1E is a multi-display including six monitors arranged in two rows and three columns. Specifically, the display device D1E includes a central monitor D1Ea, an upper monitor D1Eb, a left monitor D1Ec, a right monitor D1Ed, an upper left monitor D1Ee, and an upper right monitor D1Ef.

### Description of Communication Status for Remote Operation

In the present embodiment, the work machine 100 transmits information for causing the remote operator OP in the remote operation room RC to recognize the situation of the work machine 100 or the situation around the work machine 100 to the remote operation room RC.

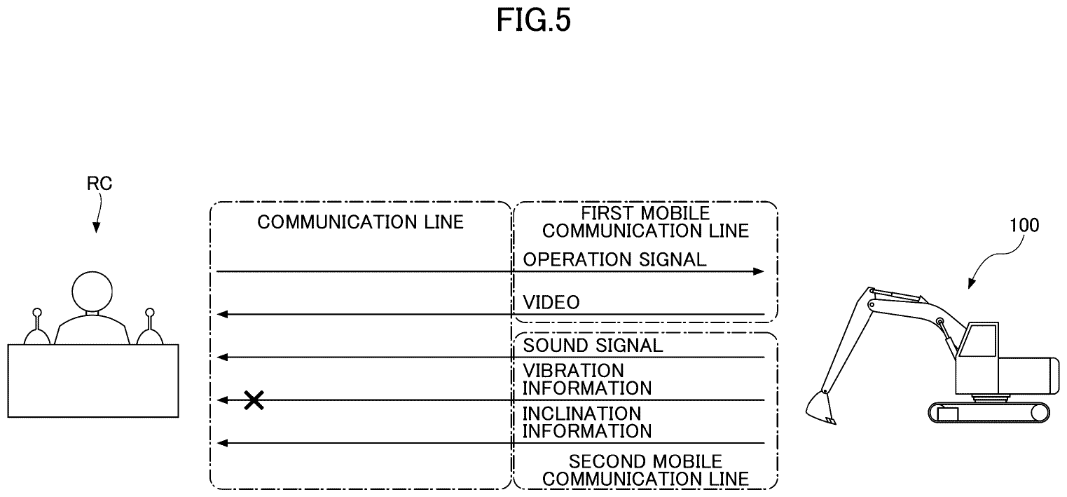

FIG. 5 is a conceptual diagram illustrating information transmitted and received between the work machine 100 and the remote operation room RC according to the present embodiment.

As illustrated in FIG. 5, for example, a video captured by the imaging device S6 is transmitted from the work machine 100 to the remote operation room RC.

In the remote operation room RC, the remote controller R40 displays the received video on the display device D1E. The video is information necessary for the remote operator OP to operate the work machine 100, and is essential information in the present embodiment.

Operation information about an operation performed with respect to the operation device R42 in the remote operation room RC is transmitted from the remote operation room RC to the work machine 100. The work machine 100 performs movement in accordance with the received operation information. The operation information is information necessary for the remote operator OP to operate the work machine 100, and is essential information in the present embodiment.

In the present embodiment, among pieces of information transmitted and received between the remote operation room RC and the work machine 100, information necessary to remotely operate the work machine 100 is defined as essential information.

Conversely, among the pieces of information transmitted and received between the remote operation room RC and the work machine 100, information that is referenced by the remote operator OP to recognize the situation of the work machine 100 or the situation around the work machine 100 and that is information other than a video is defined as additional information.

In addition, a sound signal collected by the sound collecting device M1 is transmitted from the work machine 100 to the remote operation room RC. Further, vibration information detected by the vibration detection device S7 is transmitted from the work machine 100 to the remote operation room RC. Further, inclination information detected by the machine body inclination sensor S4 is transmitted from the work machine 100 to the remote operation room RC.

In the remote operation room RC, the remote controller R40 causes the sound output device SP1E to output the received sound signal. Further, the remote controller R40 causes the vibration device R44 to output the received vibration information as vibration to be given to the remote operator OP via the operation seat DS. Further, the remote controller R40 causes the oscillation device R45 to incline the operation seat DS so as to implement the current inclination state of the work machine 100 indicated by the received inclination information.

In the present embodiment, the sound signal, the vibration information, and the inclination information are each regarded as additional information. However, in the present embodiment, the additional information is not limited to the sound signal, the vibration information, and the inclination information, and the additional information may be any information as long as the additional information is information other than a video and indicating at least one of the situation of the work machine 100 or the situation around the work machine 100. For example, the additional information may include force sense information for causing a load generated in the attachment AT to be recognized.

Further, the additional information is not limited to information transmitted from the work machine 100 to the remote operation room RC, and may include information transmitted from the remote operation room RC to the work machine 100. For example, the additional information may include a sound signal transmitted from the remote operation room RC to the work machine 100.

In the present embodiment, the communication device T1 of the work machine 100 uses a plurality of mobile communication lines in order to secure a communication band that enables transmission and reception of information in real time with the remote operation room RC. In the example illustrated in FIG. 5, the communication device T1 of the work machine 100 uses a first mobile communication line and a second mobile communication line for communication.

For example, the work machine 100 may use, among the plurality of mobile communication lines, a mobile communication line having higher communication quality to transmit or receive essential information, and may use a mobile communication line having lower communication quality to transmit or receive additional information.

The communication device T1 of the work machine 100 enables transmission and reception of essential information and transmission and reception of additional information in real time by using the plurality of mobile communication lines.

However, the communication status between the work machine 100 and the remote operation room RC is constantly changed due to various factors. Therefore, the remote controller R40 and the controller 30 monitor the communication status in order to detect a change in the communication status.

Any method may be used as a method of monitoring the communication status. For example, the remote controller R40 may detect whether an abnormality such as a packet loss or a communication delay has occurred by executing a “PING” command with a timestamp function enabled for an address that is assigned in accordance with information to be transmitted or received. For example, it may be determined that a packet loss, a communication delay, or the like has occurred in a case where it is estimated that a delay has occurred based on a response speed detected by executing the “PING” command, in a case where there is no response to the “PING” command, or in a case where a deviation has occurred in timestamps with respect to the execution interval of the “PING” command (the time difference has increased). Further, the controller 30 or the remote controller R40 may embed a timestamp, identification information of a packet, or the like in a header or the like of each packet to be transmitted, and the remote controller R40 or the controller 30 may determine whether a packet loss or a communication delay has occurred by checking the information embedded in the received packet.

The remote controller R40 controls each of essential information and additional information differently based on the communication status between the communication device T1 and the communication device T2. Specifically, the remote controller R40 performs different processes depending on whether an abnormality occurs in transmission or reception of essential information or an abnormality occurs in transmission or reception of additional information.

That is, if an abnormality occurs in transmission or reception of essential information, because it is necessary to ensure security, the remote controller R40 and the controller 30 stop movement based on operation information. The movement may be stopped by transmitting a stop signal from the remote controller R40 to the controller 30.

Conversely, if an abnormality occurs in transmission or reception of additional information, the remote operator OP can continuously operate the work machine 100 as long as an abnormality does not occur in transmission and reception of essential information.

However, if an abnormality (for example, a packet loss or a communication delay) occurs in the communication between the communication device T1 and the communication device T2, there would be a possibility that the remote operator OP erroneously identifies the situation of the work machine 100 or the situation around the work machine 100 when received additional information is output in the remote operation room RC. For example, even if the work machine 100 has already completed moving from an inclined surface to a horizontal surface, there is a possibility that the remote controller R40 continuously performs control to incline the operation seat DS based on delayed inclination information. In such a case, the remote operator OP would erroneously identify that the work machine 100 is still moving on the inclined surface. As described, if a communication delay occurs in the received additional information, there would be a possibility that output based on the additional information causes the remote operator OP to erroneously identify the situation of the work machine 100 or the situation around the work machine 100.

Then, if the remote operator OP operates the work machine 100 according to the erroneously identified situation of the work machine 100 or the erroneously identified situation around the work machine 100, there would be a possibility that the work machine 100 performs movement that is not suitable for the current situation.

In view of the above, if it is determined that a delay or a packet loss has occurred in reception of vibration information based on the communication status between the communication device T1 and the communication device T2, the remote controller R40 according to the present embodiment performs control to stop outputting vibration based on the vibration information from the vibration device R44 and to continue outputting essential information (for example, a video), for example. Similarly, if it is determined that a delay or a packet loss has occurred in reception of a sound signal or inclination information, the remote controller R40 stops outputting the sound signal from the sound output device SP1E or stops inclination control by the oscillation device R45 based on the inclination information.

### <<Functional Blocks of Work Machine>>

Referring back to FIG. 3, functional blocks of the controller 30 of the work machine 100 will be described. The functional blocks of the controller 30 are conceptual, and need not necessarily be physically configured as illustrated. All or some of the functional blocks can be functionally or physically distributed and integrated in arbitrary units. All or some of processing functions performed in each functional block are implemented by a program executed by the CPU. Alternatively, each functional block may be implemented as hardware by wired logic. The controller 30 includes an acquiring part 301, a transmission control part 302, a reception control part 303, and an actuator driving part 304 by implementing a program.

The acquiring part 301 acquires signals from various detection devices provided in the work machine 100. For example, the acquiring part 301 acquires, from the machine body inclination sensor S4, inclination information indicating an inclined state of a body (the lower traveling body 1 or the upper turning body 3) with respect to the horizontal plane. Further, the acquiring part 301 acquires position information indicating measurement results, such as the position and the direction of the work machine 100, from the positioning device PS. Further, the acquiring part 301 acquires vibration information indicating a detection result of vibration occurring in the work machine 100 from the vibration detection device S7.

Further, the acquiring part 301 acquires a video from the imaging device S6. Further, the acquiring part 301 acquires, from the sound collecting device M1, a sound signal indicating sound collected from the surroundings of the work machine 100.

The transmission control part 302 performs control to transmit various pieces of information based on results acquired by the acquiring part 301 to the remote operation room RC via the communication device T1 (an example of a first communication device). For example, the transmission control part 302 performs control to transmit inclination information detected by the machine body inclination sensor S4, vibration information indicating vibration occurring in the work machine 100, a video captured by the imaging device S6, a sound signal collected by the sound collecting device M1, and position information indicating the position and the direction of the work machine 100 to the remote operation room RC.

The reception control part 303 performs control to receive various pieces of information from the remote operation room RC via the communication device T1. For example, the reception control part 303 receives an operation signal for controlling the movement of the work machine 100 from the remote operation room RC.

The actuator driving part 304 is configured to drive an actuator mounted on the work machine 100.

In the present embodiment, the actuator driving part 304 generates and outputs an actuation signal for each of a plurality of solenoid valves included in the proportional valve 31 based on the operation signal transmitted from the remote operation room RC.

Each of the solenoid valves receiving the actuation signal increases or decreases the pilot pressure acting on a pilot port of a corresponding control valve in the control valve unit 17. As a result, a hydraulic actuator corresponding to each control valve operates at a speed corresponding to the stroke amount of the control valve.

<<Functional Blocks of Remote Operation Room>>Functional blocks of the remote controller R40 (the example of the control device) of the remote operation room RC will be described. The functional blocks of the remote controller R40 are conceptual, and need not necessarily be physically configured as illustrated. All or some of the functional blocks can be functionally or physically distributed and integrated in arbitrary units. All or some of processing functions performed in each functional block are implemented by a program executed by the CPU. Alternatively, each functional block may be implemented as hardware by wired logic. The remote controller R40 includes a reception control part 401, a display control part 402, an output control part 403, a determination part 404, a signal generation part 405, and a transmission control part 406 by implementing a program.

The reception control part 401 performs control to receive various pieces of information from the work machine 100 via the communication device T2.

For example, the reception control part 401 performs control to receive essential information from the work machine 100. Specifically, the reception control part 401 performs control to receive a video captured by the imaging device S6.

As another example, the reception control part 401 performs control to receive additional information from the work machine 100. Specifically, the reception control part 401 performs control to receive inclination information detected by the machine body inclination sensor S4, vibration information detected by the vibration detection device S7, and a sound signal collected by the sound collecting device M1.

Further, the reception control part 401 performs control to receive position information indicating the position and the direction of the work machine 100 from the work machine 100.

The display control part 402 performs control to display various kinds of information on the display device D1E. For example, the display control part 402 performs control to display a video captured by the imaging device S6 on the display device D1E as a video indicating the surroundings of the work machine 100. Further, the display control part 402 performs control to display information indicating the current situation of the work machine 100 on the display device D1E, based on detection results of various detection devices of the work machine 100 received by the reception control part 401.

The output control part 403 performs output control based on additional information. For example, the output control part 403 performs control to output a received sound signal from the sound output device SP1E.

Further, the output control part 403 performs inclination control of the operation seat DS via the oscillation device R45, based on received inclination information. In the present embodiment, output based on the inclination information is not limited to the inclination control of the operation seat DS. For example, there is also a method in which the display control part 402 performs control to display information (for example, an icon of the work machine 100 or the like) that allows the inclination angle of the work machine 100 to be recognized on the display device D1E.

Further, the output control part 403 performs vibration control of the operation seat DS via the vibration device R44 based on received vibration information.

The determination part 404 determines whether an abnormality has occurred in the communication status of each of essential information and additional information being received. For example, the determination part 404 determines whether a packet loss or a communication delay has occurred in each of essential information and additional information being received. Any method may be used as a method of determining whether a packet loss or a communication delay has occurred. For example, whether or not an abnormality such as a packet loss or a communication delay has occurred may be detected by executing a “PING” command, or an abnormality such as a packet loss or a communication delay may be detected by referencing information embedded in a header or the like of each packet.

Further, in addition to determining whether an abnormality has occurred in the communication status, the determination part 404 may determine the occurrence of any other abnormality. For example, the determination part 404 may determine whether a delay or an abnormality has occurred in encoding or decoding of a sound signal included in additional information. Any method may be used as a method of determining whether a delay or an abnormality has occurred in encoding of a sound signal. For example, the determination part 404 may determine whether a delay or an abnormality has occurred, based on notifications (for example, a PING or the like with a timestamp function enabled) output from the controller 30 of the work machine 100 at timings at which encoding of a sound signal is started and ended.

The signal generation part 405 generates an operation signal for controlling the movement of the work machine 100 according to information received from the operation sensor R43.

In addition, if the determination part 404 determines that an abnormality has occurred in essential information being received, the signal generation part 405 generates an operation signal for stopping the movement of the work machine 100.

The transmission control part 406 performs control to transmit various kinds of information to the work machine 100. For example, the transmission control part 406 performs control to transmit an operation signal generated by the signal generation part 405 to the work machine 100.

If the determination part 404 determines that an abnormality has occurred in the communication status of each of pieces of additional information being received, the determination part 404 stops outputting the pieces of additional information from various output devices and continues to output essential information (for example, a video) to the display device D1E.

For example, if the determination part 404 determines that a packet loss or a communication delay has occurred in inclination information being received, the output control part 403 performs control to stop inclination control of the operation seat DS by the oscillation device R45. Further, when the output control part 403 performs the control to stop the inclination control, the output control part 403 performs control to reduce the inclination amount based on the inclination information.

Further, if the determination part 404 determines that a packet loss or a communication delay has occurred in vibration information being received, the output control part 403 performs control to stop outputting vibration from the vibration device R44. At this time, the output control part 403 performs control to reduce the amount of the vibration output from the vibration device R44 based on the vibration information.

Further, if the determination part 404 determines that a packet loss or a communication delay has occurred in a sound signal being received, the determination part 404 determines whether a person is present around the work machine 100. Only when it is determined that no person is present, the output control part 403 performs control to stop outputting sound from the sound output device SP1E. At this time, the output control part 403 performs control to reduce the volume of the sound output from the sound output device SP1E. That is, in a case where a person is present around the work machine 100, the person may utter sound. Even if the sound uttered by the person is interrupted or delayed, it is considered preferable to output the sound to the remote operator OP. Therefore, in the present embodiment, even if a packet loss or a delay occurs in a sound signal, sound indicated by the sound signal is continuously output when a person is present around the work machine 100.

After output based on additional information is stopped, the determination part 404 determines whether an abnormality in the communication status when receiving the additional information is eliminated.

For example, if the determination part 404 determines that a packet loss or a communication delay in inclination information being received is eliminated, the output control part 403 performs control to resume inclination control of the operation seat DS by the oscillation device R45. In addition, when the output control part 403 performs the control to resume the inclination control, the output control part 403 performs control to increase the inclination amount based on the inclination information.

Similarly, if the determination part 404 determines that a packet loss or a communication delay in vibration information or a sound signal being received is eliminated, the output control part 403 performs control to resume outputting vibration from the vibration device R44 or outputting sound from the sound output device SP1E. At this time, the output control part 403 performs control to increase the amount of the vibration output from the vibration device R44 based on the vibration information or increase the volume of the sound output from the sound output device SP1E.

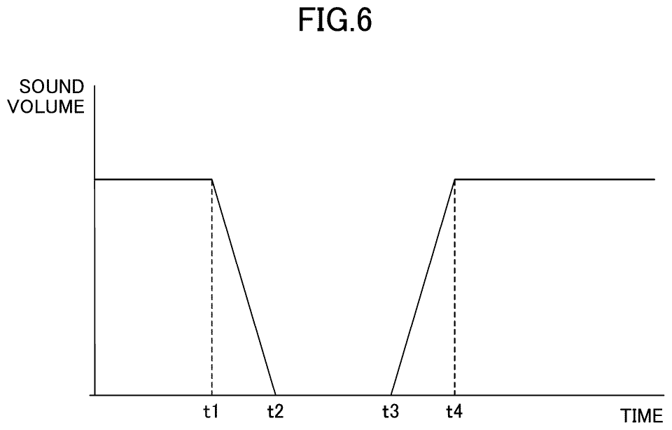

FIG. 6 is a diagram illustrating an example of output control of the sound volume by the output control part 403 according to the present embodiment. In the example illustrated in FIG. 6, the vertical axis represents the sound volume and the horizontal axis represents the time. In the example illustrated in FIG. 6, the vertical axis represents the sound volume; however, the vertical axis may represent the vibration amount or the inclination amount in the same manner, and the description thereof will be omitted. In the example illustrated in FIG. 6, it is assumed that there is no person around the work machine 100.

In the example illustrated in FIG. 6, at a time t1, the determination part 404 determines that a packet loss or a communication delay has occurred in a sound signal being received. Therefore, the output control part 403 starts control to reduce the volume of sound output from the sound output device SP1E. Then, at a time t2, the output control part 403 stops outputting the sound from the sound output device SP1E.

Thereafter, at a time t3, the determination part 404 determines that the packet loss or the communication delay is eliminated in the sound signal being received. Then, the output control part 403 resumes outputting the sound from the sound output device SP1E. Then, the output control part 403 starts control to increase the volume of the sound output from the sound output device SP1E. Subsequently, at a time t4, the output control part 403 stops the control to increase the volume of the sound output from the sound output device SP1E.

In the present embodiment, by performing control to reduce the vibration amount, the inclination amount, or the sound volume based on additional information or performing control to increase the vibration amount, the inclination amount, or the sound volume, it is possible to prevent a sudden stop of output or a sudden start of output, thereby suppressing startling of the remote operator OP. Therefore, the safety of an operation by the remote operator OP can be secured.

When output related to additional information from any of various output devices is stopped, the display control part 402 performs control to display information indicating that the output is to be stopped on the display device D1E.

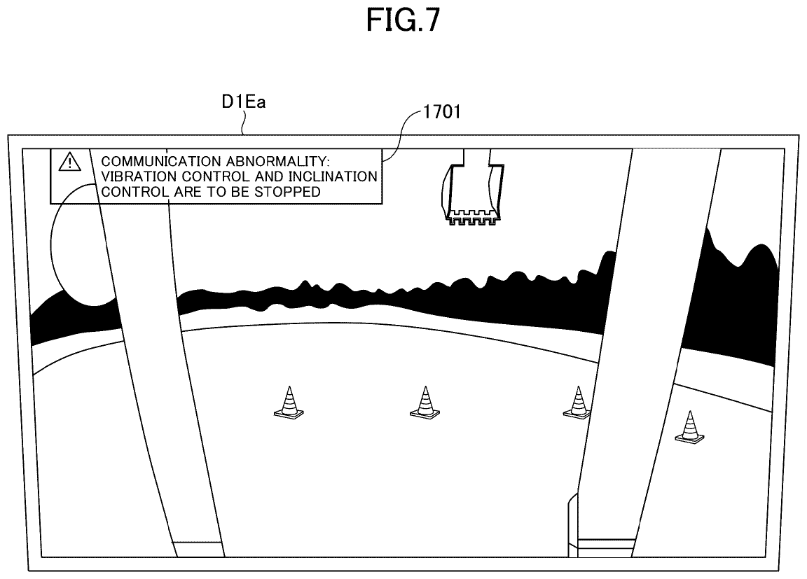

FIG. 7 is a diagram illustrating an example of a screen displayed by the display control part 402 according to the present embodiment. FIG. 7 illustrates an example of a screen displayed by the display control part 402 in a case where the determination part 404 determines that a packet loss or a communication delay has occurred in vibration information and inclination information being received.

In the example illustrated in FIG. 7, a video captured by the front camera of the imaging device S6 is displayed on the central monitor D1Ea of the display device D1E. The display control part 402 superimposes and displays a message indicating “Communication abnormality: vibration control and inclination control are to be stopped” on the video. According to the present embodiment, the message is displayed translucently, for example, and thus the video can be visually recognized through the message. Therefore, the displayed message is less likely to hinder an operation of the work machine 100. After the message is displayed, the output control part 403 starts control to reduce the vibration amount and the inclination amount.

The above-described displayed message allows the remote operator OP to recognize that the communication abnormality has occurred without turning his/her eyes away from the line of sight. Further, the remote operator OP can recognize that the vibration control and the inclination control are to be stopped. The remote operator OP can estimate the current communication status based on the display and the control. Therefore, the remote operator OP can perform an operation in consideration of the communication status, and thus safety can be improved.

Further, when the output related to the additional information from any of the various output devices is resumed, the display control part 402 performs control to display information indicating that the output is to be resumed on the display device D1E. For example, when the determination part 404 determines that the packet loss or the communication delay in the vibration information and the inclination information is eliminated, the display control part 402 displays a message indicating “Communication recovery: vibration control and inclination control are to be resumed” on the display device D1E. The remote operator OP can recognize that the vibration control and the inclination control are to be resumed based on the display and the control. Thereafter, the remote operator OP can estimate the situation of the work machine 100 or the situation around the work machine 100 based on the vibration control and the inclination control and perform an operation, and thus safety can be improved.

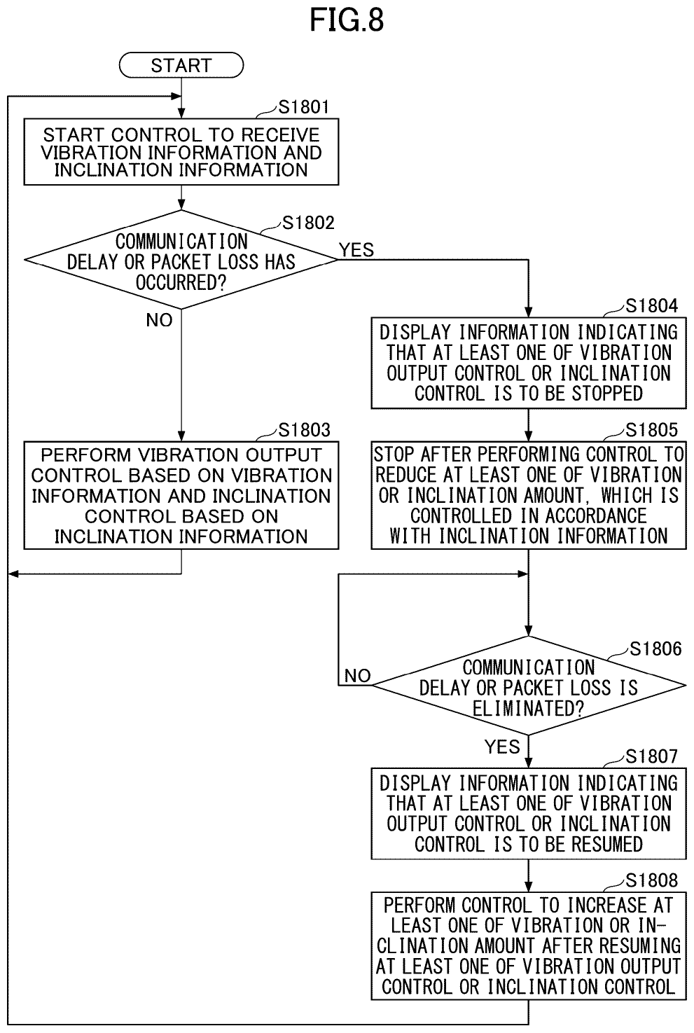

Control in accordance with the communication status of vibration information and inclination information, each of which is additional information, by the remote controller R40 according to the present embodiment will be described. FIG. 8 is a flowchart illustrating a process in accordance with the communication status of vibration information and inclination information by the remote controller R40 according to the present embodiment.

The reception control part 401 of the remote controller R40 starts control to receive vibration information and inclination information (S1801).

The determination part 404 determines whether a communication delay or a packet loss has occurred in each of the vibration information and inclination information being received (S1802). As a determination condition for determining whether a communication delay or a packet loss has occurred, any determination condition may be used, or a determination condition used in the related art or the like may be used.

If the determination part 404 determines that no communication delay or no packet loss has occurred (S1802: NO), the output control part 403 performs vibration output control with respect to the operation seat DS based on the received vibration information and inclination control with respect to the operation seat DS based on the inclination information (S1803). Thereafter, the process is performed again from S1801.

Conversely, if the determination part 404 determines that a communication delay or a packet loss has occurred in at least one of the vibration information or inclination information being received (S1802: YES), the display control part 402 displays information indicating that at least one of the vibration output control or the inclination control is to be stopped (S1804).

After the output control part 403 performs control to reduce at least one of vibration, which is output in accordance with the vibration information, or the inclination amount, which is controlled in accordance with the inclination information, the output control part 403 stops at least one of the vibration output control or the inclination control (S1805).

Note that, of the vibration output control and the inclination control, control corresponding to the information (at least one of the vibration information or the inclination information) in which the communication delay or the packet loss has occurred is stopped.

Then, the determination part 404 determines whether the communication delay or the packet loss in at least one of the vibration information or inclination information being received is eliminated (S1806).

If the determination part 404 determines that the communication delay or the packet loss is not eliminated (S1806: NO), the determination part 404 performs S1806 again after a predetermined period of time has elapsed.

Conversely, if the determination part 404 determines that the communication delay or the packet loss is eliminated (S1806: YES), the display control part 402 displays information indicating that at least one of the vibration output control or the inclination control is to be resumed (S1807).

After the output control part 403 resumes at least one of the vibration output control or the inclination control, the output control part 403 performs control to increase at least one of the vibration, which is output in accordance with the vibration information, or the inclination amount, which is controlled in accordance with the inclination information (S1808). Thereafter, the process is performed again from S1801. Note that, of the vibration output control and the inclination control, control corresponding to the information (at least one of the vibration information or the inclination information) in which the communication delay or the packet loss is eliminated is resumed.

As described above, after the remote controller R40 according to the present embodiment stops output related to additional information, that is, output related to at least one of vibration information or inclination information, the remote controller R40 resumes the output related to the additional information based on the communication status between the communication device T1 and the communication device T2. When a communication delay or the like is recovered, at least one of the output of vibration and inclination control is resumed. Therefore, the remote operator OP can recognize the situation of the work machine 100 or the situation around the work machine 100, and thus safety can be improved.

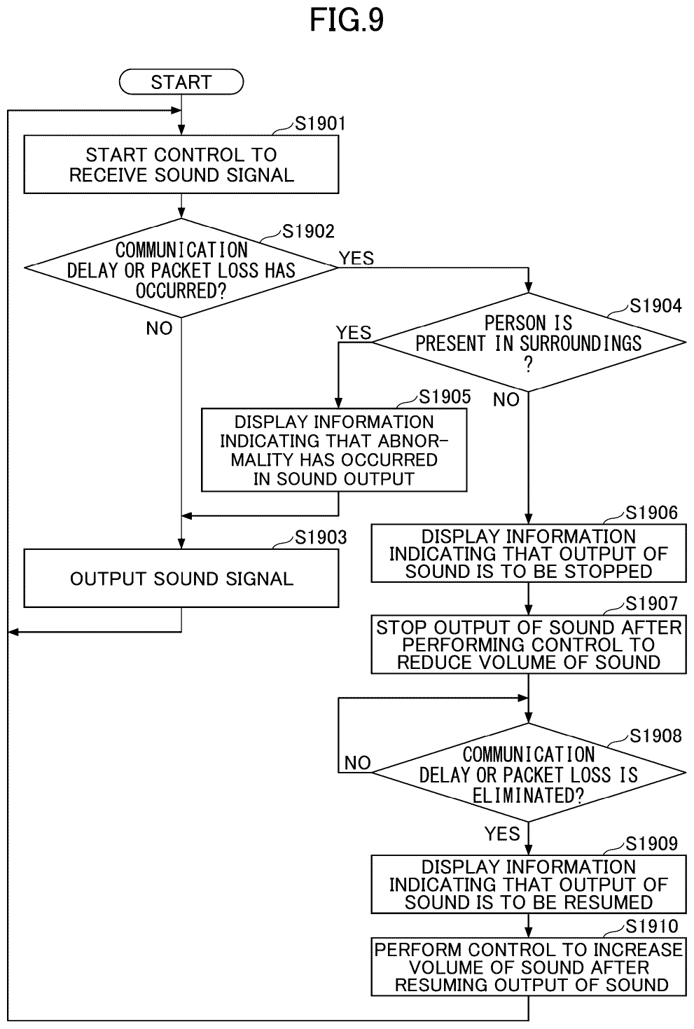

Next, control in accordance with the communication status of a sound signal, which is additional information, by the remote controller R40 according to the present embodiment will be described. FIG. 9 is a flowchart illustrating a process in accordance with the communication status of a sound signal by the remote controller R40 according to the present embodiment.

The reception control part 401 of the remote controller R40 starts control to receive a sound signal (S1901).

The determination part 404 determines whether a communication delay or a packet loss has occurred in the sound signal being received (S1902).

As a determination condition for determining whether a communication delay or a packet loss has occurred, any determination condition may be used, or a determination condition used in the related art or the like may be used.

If the determination part 404 determines that no communication delay or no packet loss has occurred (S1902: NO), the output control part 403 performs control to output sound, indicated by the sound signal being received, from the sound output device SP1E (S1903). Thereafter, the process is performed again from S1901.

Conversely, if the determination part 404 determines that a communication delay or a packet loss has occurred in the sound signal being received (S1902: YES), the determination part 404 determines whether a person is present in the surroundings based on a video being received (S1904). If the determination part 404 determines that a person is present in the surroundings (S1904: YES), the display control part 402 displays information indicating that an abnormality (for example, a delay, an interruption, or the like) has occurred in the output of the sound (S1905). Then, the output control part 403 performs control to output the sound, indicated by the sound signal being received, from the sound output device SP1E (S1903). Thereafter, the process is performed again from S1901.

Conversely, if the determination part 404 determines that no person is present in the surroundings based on a video being received (S1904: NO), the display control part 402 displays information indicating that the output of the sound is to be stopped (S1906).

Thereafter, after the output control part 403 performs control to reduce the volume of the sound, which is output based on the sound signal, the output control part 403 stops output control of the sound (S1907).

Then, the determination part 404 determines whether the communication delay or the packet loss in the sound signal being received is eliminated (S1908).

If the determination part 404 determines that the communication delay or the packet loss is not eliminated (S1908: NO), the determination part 404 performs S1908 again after a predetermined period of time has elapsed.

Conversely, if the determination part 404 determines that the communication delay or the packet loss is eliminated (S1908: YES), the display control part 402 displays information indicating that the output of the sound is to be resumed (S1909).

After the output control part 403 resumes the output of the sound, the output control part 403 performs control to increase the volume of the sound, which is output based on the sound signal (S1910).

Thereafter, the process is performed again from S1901. In a case where it is determined that a person appears in a received video, the remote controller R40 according to the present embodiment continues the output of sound indicated by a sound signal regardless of the communication status.

Therefore, although there is a possibility that an abnormality such as a delay or an interruption has occurred in the output sound, the remote operator OP can hear the sound uttered from the person present in the surroundings of the work machine 100. Therefore, the remote operator OP can recognize the situation around the work machine 100, and thus safety can be improved.

The remote controller R40 according to the present embodiment continuously performs a process of displaying a video included in essential information on the display device D1E while performing the processes illustrated in FIG. 8 and FIG. 9. Accordingly, if an abnormality occurs in additional information, the remote operator OP stops output based on the additional information. Thus, the possibility that the surrounding situation or the situation of the work machine 100 is erroneously determined based on the additional information can be reduced. In addition, the remote operator OP can determine the surrounding situation based on the video and continue to operate the work machine 100.

### Second Embodiment

In the first embodiment, an example in which an abnormality occurs in the communication status when additional information is received has been described. In the second embodiment, an example in which an abnormality occurs in the communication status when essential information is received will be described. A configuration of a remote operation system SYS according to the second embodiment is the same as that of the first embodiment, and the description thereof will be omitted.

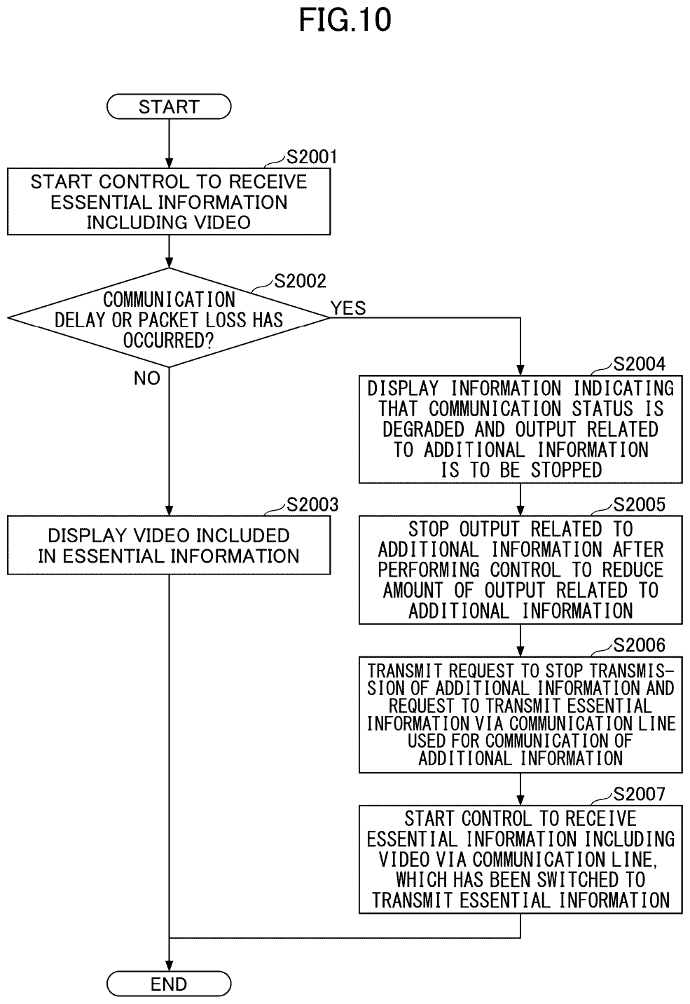

Next, control in accordance with the communication status of essential information by the remote controller R40 according to the present embodiment will be described. FIG. 10 is a flowchart illustrating a process in accordance with the communication status of essential information by the remote controller R40 according to the present embodiment.

The reception control part 401 of the remote controller R40 starts control to receive essential information including a video (S2001).

The determination part 404 determines whether a communication delay or a packet loss has occurred in the essential information being received (S2002).

If the determination part 404 determines that no communication delay or no packet loss has occurred (S2002: NO), the display control part 402 performs control to display the video, included in the essential information being received, on the display device D1E, for example, (S2003).

Conversely, if the determination part 404 determines that a communication delay or a packet loss has occurred in the essential information being received (S2002: YES), the display control part 402 displays information indicating that the communication status is degraded and output related to additional information is to be stopped (S2004).

Thereafter, the output control part 403 performs control to reduce the amount of the output related to the additional information (for example, at least one of vibration information, inclination information, or a sound signal), and subsequently, stops the output related to the additional information (S2005).

Then, the transmission control part 406 transmits, to the work machine 100, a request to stop the transmission of the additional information and a request to transmit the essential information via a communication line used for the communication of the additional information (S2006).

Thereafter, the reception control part 401 of the remote controller R40 starts control to receive the essential information including the video via the communication line, which has been switched to transmit the essential information (S2007).

In a case where it is determined that an abnormality has occurred in the communication status of essential information, the remote controller R40 according to the present embodiment causes the controller 30 to stop the transmission of additional information and uses a communication band of the additional information for the communication of the essential information, thereby continuing the communication of the essential information. In the present embodiment, as a case where the communication status of essential information is determined not to satisfy a predetermined condition, a case where an abnormality is determined to have occurred in the communication status of the essential information, in other words, a case where a communication delay or a packet loss is determined to have occurred has been described. However, in the present embodiment, the case where the communication status of the essential information is determined not to satisfy the predetermined condition is not limited to the case where the communication delay or the packet loss is determined to have occurred. The case where the communication status of the essential information is determined not to satisfy the predetermined condition may be a case where an abnormality occurs in the received essential information to the extent that it becomes difficult for the remote operator OP to operate the work machine 100. Note that the remote controller R40 according to the present embodiment does not necessarily stop the transmission of the additional information, and the remote controller R40 may continue the communication of the essential information by reducing the communication amount of the additional information as compared to before it is determined that the communication status of the essential information does not satisfy the predetermined condition, and using a communication band of the additional information for the communication of the essential information. In the present embodiment, the stability of receiving the essential information can be improved by using the communication band of the additional information for the reception of the essential information according to the communication status of the essential information. Therefore, the remote operator OP can easily grasp the situation of the work machine 100 or the situation around the work machine 100 based on the essential information, and thus safety can be improved.

### Third Embodiment

In the above-described embodiment, control in the case of receiving additional information or essential information has been described. However, the above-described embodiment is not limited to the control in the case of receiving the additional information or the essential information. Therefore, in the third embodiment, control in the case of transmitting additional information and essential information will be described. A configuration of a remote operation system SYS according to the third embodiment is the same as that of the first embodiment, and thus the description thereof will be omitted.

The communication device T2 according to the present embodiment transmits essential information including an operation signal to the communication device T1 of the work machine 100 as controlled by the remote controller R40.

In the present embodiment, the sound collecting device M1E of the remote operation room RC collects sound uttered by the remote operator OP as a sound signal. The communication device T2 transmits the sound signal to the communication device T1 of the work machine 100 as controlled by the remote controller R40. In the present embodiment, the sound signal transmitted to the communication device T1 of the work machine 100 is additional information.

The remote controller R40 performs control when the additional information and the essential information are transmitted, which is the same as the control when the additional information and the essential information are received in the above-described embodiments.

For example, if the determination part of the remote controller R40 determines that an abnormality has occurred in the communication status of the essential information being transmitted, the transmission control part 406 stops the transmission of the additional information to the work machine 100 and performs control such that the essential information is transmitted via a communication line used for the communication of the additional information. As a method of switching a communication line, any method including publicly-known methods may be used.

If it is determined that an abnormality has occurred in the communication status of the essential information, the remote controller R40 according to the present embodiment stops the transmission of the additional information, and continues the transmission of the essential information by using a communication band of the additional information for the transmission of the essential information. Note that the remote controller R40 according to the present embodiment does not necessarily stop the transmission of the additional information, and the remote controller R40 may continue the transmission of the essential information by reducing the communication amount of the additional information as compared to before it is determined that the abnormality has occurred in the communication status of the essential information, and using the communication band of the additional information for the transmission of the essential information. In the present embodiment, the stability of transmitting the essential information can be improved by using the communication band of the additional information for the transmission of the essential information according to the communication status of the essential information. Therefore, in the present embodiment, by stabilizing the transmission of the essential information including the operation signal, it is possible to improve the operability and improve the stability of the movement of the work machine 100.

### Effects

In the above-described embodiments, safety can be improved by enabling the output or transmission of information in accordance with the current communication status between the communication device T1 of the work machine 100 and the communication device T2 of the remote operation room RC.

In the above-described embodiments, in a case where an abnormality occurs in the communication status of additional information between the communication device T1 of the work machine 100 and the communication device T2 of the remote operation room RC, control is performed such that output related to the additional information is stopped and output of essential information is continued. Therefore, the operation of the work machine 100 can be continued based on the output of the essential information, and also the possibility that the remote operator OP makes an erroneous determination based on the additional information can be reduced. Accordingly, safety can be improved.

The preferred embodiments and modifications thereof of the present disclosure have been described. However, the present disclosure is not limited to the above-described embodiments. Various modifications, substitutions, and the like can be applied to the above-described embodiments without departing from the scope of the present disclosure. Each of the features described with reference to the above-described embodiments may be appropriately combined as long as they are not technically inconsistent.

What is claimed is:

1. A remote operation system comprising:
a work machine including
an imaging device configured to capture a video around the work machine,
a detection device configured to detect additional information indicating information other than the video among pieces of information indicating at least one of a situation of the work machine or a situation around the work machine, and
a first communication device configured to transmit the video and the additional information;
a remote operation room including
an operation device,
a second communication device configured to transmit operation information from the operation device to the first communication device and receive the video and the additional information,
a display device configured to display the video, and
an output device configured to output the additional information; and
a control device configured to perform control to transmit or receive essential information and the additional information between the first communication device and the second communication device, the essential information including at least one of the video or the operation information and being necessary to operate the work machine, wherein
the control device controls each of the essential information and the additional information differently based on a communication status between the first communication device and the second communication device.

2. The remote operation system according to claim 1, wherein the control device performs control to stop outputting the additional information from the output device and to continue to output the essential information, based on a communication status of the additional information between the first communication device and the second communication device.

3. The remote operation system according to claim 2, wherein
the additional information received by the second communication device from the first communication device includes a sound signal indicating sound collected from surroundings of the work machine, and
in response to determining that a person appears in the received video, the control device continues to output the sound indicated by the sound signal included in the additional information regardless of the communication status.

4. The remote operation system according to claim 2, wherein, after the control device stops outputting the additional information, the control device resumes outputting the additional information from the output device based on the communication status between the first communication device and the second communication device.

5. The remote operation system according to claim 4, wherein the control device performs control to reduce an output amount of the additional information when the control device stops outputting the additional information, or the control device performs control to increase the output amount of the additional information when the control device resumes outputting the additional information.

6. The remote operation system according to claim 4, wherein the control device outputs, to the display device, information indicating that the outputting of the additional information from the output device is stopped when the control device stops outputting the additional information from the output device, or the control device outputs, to the display device, information indicating that the outputting of the additional information from the output device is resumed when the control device resumes outputting the additional information from the output device.

7. The remote operation system according to claim 1, wherein, in response to determining that a communication status of the essential information between the first communication device and the second communication device does not satisfy a predetermined condition, the control device reduces a communication amount of the additional information as compared to before determining that the communication status does not satisfy the predetermined condition, and continues to transmit or receive the essential information.
